(19) United States
(12) Patent Application Publication
(10) Pub. No.: US 2015/0095802 A1
(43) Pub. Date: Apr. 2, 2015

(54) MECHANISM FOR COMPACTING SHARED CONTENT IN COLLABORATIVE COMPUTING SESSIONS

(71) Applicant: Cisco Technology, Inc., San Jose, CA (US)

(72) Inventors: Haihua Huang, Suzhou (CN); Qi Yang, Suzhou (CN); Yong Qian, Suzhou (CN); Kejun Xia, Suzhou (CN)

(73) Assignee: Cisco Technology, Inc., San Jose, CA (US)

(21) Appl. No.: 14/039,428

(22) Filed: Sep. 27, 2013

(51) Int. Cl. H04L 29/06

(52) U.S. Cl. CPC H04L 65/403
USPC 715/753

(57) ABSTRACT

In an example embodiment disclosed herein, there is described methods and a system for sharing of content in collaborative computing sessions. The methods and the system are operable to initiate a collaborative computing session between a plurality of participant devices, wherein at least one participant device operates as a presenter device to share data with at least one other participant viewer device. The methods and system are further operable to designate data to be shared with at least one viewer device. The methods and system are also operable to transmit the designated shared data to the at least one viewer device, render the shared data for display on at least one viewer device, wherein the shared data is rendered in accordance with display capabilities of the at least one viewer device, and display the rendered shared data on the at least one viewer device.

### TECHNICAL FIELD

The present disclosure relates generally to computer networks, and more particularly, to sharing of content in collaborative computing sessions.

### BACKGROUND

Collaborative computing sessions, such as interactive conferences (e.g., conferences or meetings), may be supported by a network of servers and client computers. In particular, one feature available to online meetings or data conferencing systems is to allow computer users at different locations to communicate via a computer network and share applications stored and/or executed on one of the user's computers, such as through a software program that enables the users to share applications (e.g., sharing a presenter's application with one or more attendees/viewers).

A conferencing technique for sharing applications during a data conference is to share a predefined area of the presenter's computer screen with an attendee (e.g., “desktop sharing”). Using this technique, the presenter's computer captures an image within a predefined portion of the presenter's computer screen/display (e.g., the entire screen or a portion of the screen). The captured image within the predefined portion of the presenter's computer is then transmitted to the attendee's computer for viewing. A refinement to this conventional technique allows the presenter to selectively share an application with the attendee (e.g., “application sharing”). In some situations, an attendee may be using a mobile device to access the shared content.

### BRIEF DESCRIPTION OF THE DRAWINGS

The accompanying drawings incorporated herein and forming a part of the specification illustrate the examples embodiments.

FIG. 1 is a block diagram illustrating an example computer network for collaborative computing sessions.

FIG. 2 is a block diagram illustrating an example participant device for collaborative computing sessions.

FIG. 3 is a block diagram illustrating an example server for collaborative computing sessions.

FIG. 4 is a block diagram illustrating an example computer network for content sharing in collaborative computing sessions.

FIG. 5 illustrates an example of a methodology for sharing content in a collaborative computing session.

FIG. 6 illustrates an example display for a presenter device.

FIG. 7 illustrates an example display for a viewer device.

FIG. 8 illustrates an example display for a presenter device.

FIG. 9 illustrates an example display for a viewer device.

FIG. 10 illustrates an example display for a viewer device.

FIG. 11 illustrates an example of a methodology for application sharing in a collaborative computing session.

FIG. 12 illustrates an example display for a viewer device.

FIG. 13 illustrates an example of a methodology for desktop sharing in a collaborative computing session.

FIG. 14 illustrates an example display for a viewer device.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In an example embodiment described herein, there is disclosed a method, apparatus, and logic for sharing content in collaborative computing sessions. A collaborative computing session is initiated between a plurality of participant devices in data communication with each other, wherein at least one participant device operates as a presenter device to share data associated with the group consisting of at least one application program executing on the presenter device, a predefined area of a display of the presenter device, and combinations thereof, with at least one other participant viewer device. Data associated with the group consisting of at least one application program executing on the presenter device, a predefined area of the display of the presenter device, and combinations thereof, is designated to be shared with at least one viewer device. The designated shared data is transmitted to the at least one viewer device, rendered for display on at least one viewer device, wherein the shared data is rendered in accordance with display capabilities of the at least one viewer device, and the rendered shared data is displayed on the at least one viewer device.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

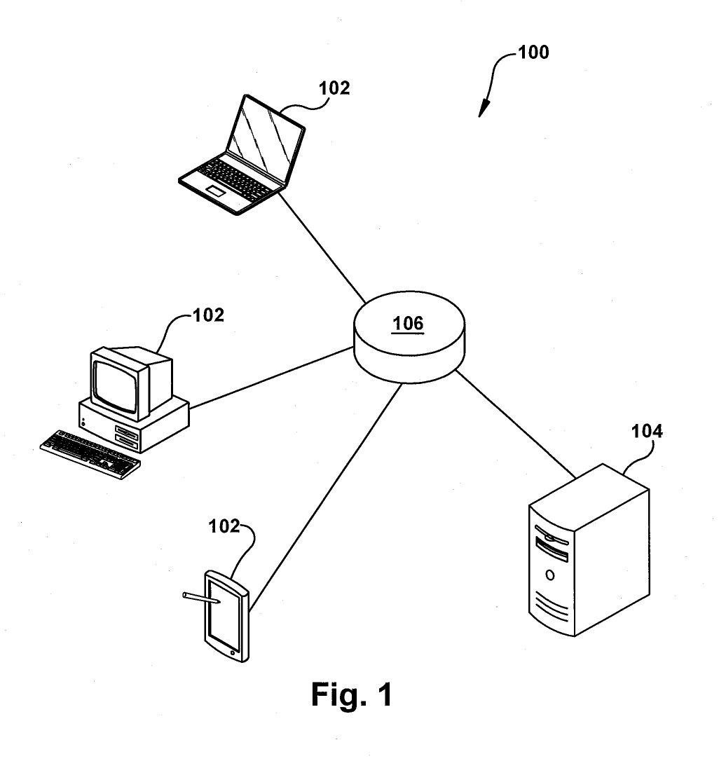

FIG. 1 is a schematic diagram illustrating an example computer architecture 100 in which the methods and apparatuses for sharing content in collaborative computing sessions are displayed. The example architecture includes a plurality of participant devices 102, a server 104, and a network 106 connecting participant devices 102 to server 104 and participant devices 102 to other participant devices as required. Participant devices, as described below, may be any personal computing device known in the art including, for example and without limitation, a laptop computer, a personal computer, a personal data assistant, a web-enabled cellular telephone, a smart phone, a proprietary network device, or other web-enabled electronic device. Communication between the participant devices 102 and the server 104 within the network 106 is suitably made possible with the use of communication protocols, which govern how computers exchange data over a network, as is known in the art. Those skilled in the art will understand that any number of devices, servers, links, etc. may be used in the computer network, and that the view shown herein is for simplicity.

In this environment, a number of participants may interact in an online, interactive, or collaborative setting. Such a setting can be for a meeting, training or education, or support, or any other event that may require a number of participants to work together, interact, collaborate, or otherwise participate, such as web conferences, online meetings, etc. As used herein, the phrase “collaborative computing session” may be used to describe these settings/events, particularly where a number of participant computers/devices collaborate in an established session, as may be appreciated by those skilled in the art. Also, as used herein, a “session” describes a generally lasting communication between one or more participant devices 102 through server 104 and the network 106. Those skilled in the art will understand that the session may be implemented or established using protocols and services as is known in the art. Conversely, a “meeting” describes a personal layer of communication overlaid upon the session where participants/users communicate with each other. Moreover, while the terms “session” and “meeting” may generally be used interchangeably herein to denote a collaboration of users or devices, particular instances of their use may denote a particular distinction (e.g., a session may start with attendees joining/connecting to the server, while a meeting may not start until a host/presenter joins the session), as may be understood by those skilled in the art.

In other words, a collaboration session comprises a plurality of devices or “participant devices,” of which “attendee devices” are configured to view/receive content submitted or “shared” by “presenter devices.” In some instances, the attendee devices are capable of modifying the content shared by the presenter device.

In particular, each participant (e.g., hosts/presenters and/or attendees) may operate a participant device 102. Each participant device 102 may comprise an electronic device with capability for visual and/or auditory presentation. Thus, a participant device 102 can be, for example, a laptop computer, a personal computer, a personal data assistant, a web-enabled cellular telephone, a smart phone, a proprietary network device, or other web-enabled electronic device. Each participant device 102 supports communication by a respective participant, in the form of suitable input device (e.g., keyboard, mouse, stylus, keypad, etc.) and output device (e.g., monitor, display, speech, voice, or other device supporting the presentation of audible/visual information).

The meeting (collaborative computing session) of the various participants may be supported by a server 104 which may be maintained or operated by one or more of the participants and/or a third-party service provider. The server 104 may be a computer system that is connected to network 106, and which may comprise and appear as one or more server computers thereon. Server 104 may store information (e.g., content) and application modules which can be provided to the participant devices 102. In some embodiments, these application modules are downloadable to the participant devices 102 and may support various functions that may be required for an interactive meeting or collaborative effort among the participants. The participant devices 102 and the server 104 may interact in a client/server architecture, which may provide high performance and security for a multi-participant collaborative environment.

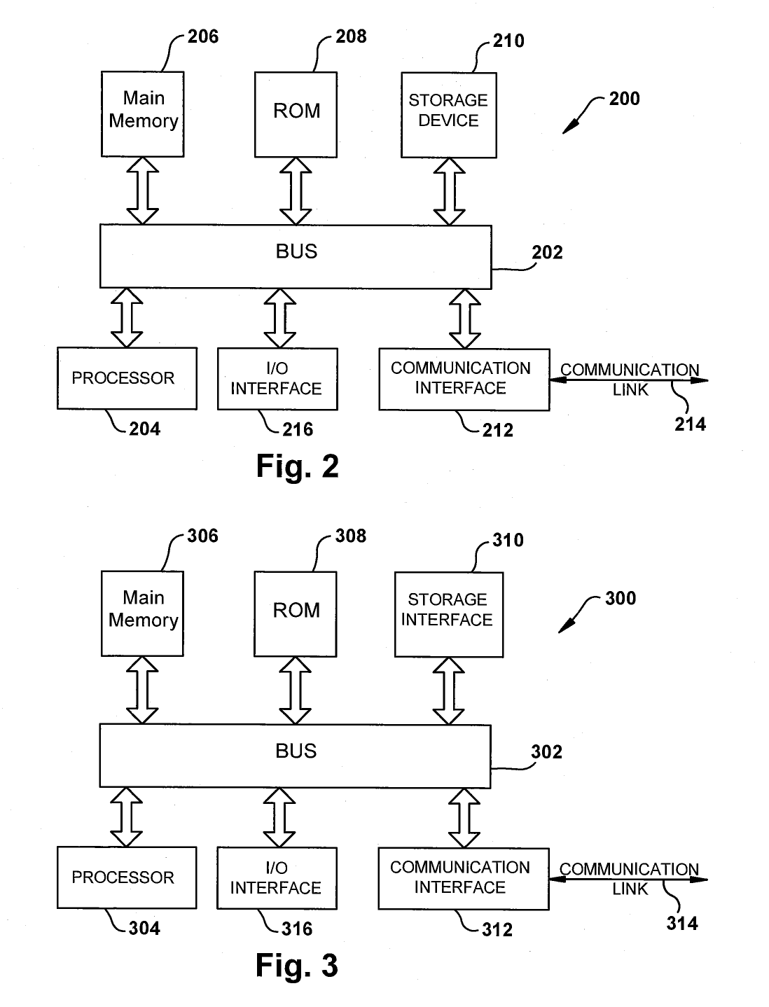

FIG. 2 illustrates a schematic block diagram of an example participant device 200 that may be advantageously used with one or more embodiments described herein, e.g., for collaborative computing. Illustratively, participant device 200 may be implemented or incorporated in any suitable computer such as, for example, a laptop computer, a personal computer, a personal data assistant, a web-enabled cellular telephone, a smart phone, a proprietary network device, or other web-enabled electronic device.

In particular, the participant device 200 comprises a bus 202 or other communication mechanism for communicating information and a processor 204 coupled with the bus for processing information. The participant device 200 also includes a main memory 206, such as random access memory (RAM) or other dynamic storage device coupled to bus 202 for storing information and instructions to be executed by processor 204. Main memory 206 also may be used for storing a temporary variable or other intermediate information during execution of instructions to be executed by processor 204. The participant device 200 further includes a read only memory (ROM) 208 or other static storage device coupled to bus 202 for storing static information and instructions for processor 204. The participant device 200 may further comprise a storage device 210, such as a magnetic disk, optical disk, and/or flash storage, which is provided and coupled to bus 202 for storing information and instructions.

The processor 204, in connection with the memory 206, is configured to implement the functionality described herein with reference to the participant device. The memory 206 stores software programs or other executable program instructions associated with the embodiments described herein. Such instructions may be read into memory 206 from another computer-readable medium, such as storage device 210.

The processor 204 comprises the necessary elements or logic adapted to execute the software programs to generally perform functions relating to collaborative computing sessions, as described herein. Execution of the sequence of instructions contained in main memory 206 causes processor 204 to perform the process steps described herein. One or more processors in a multi-processing arrangement may also be employed to execute the sequences of instructions contained in main memory 206. In alternative embodiments, hard-wired circuitry may be used in place of or in combination with software instructions to implement an example embodiment. Thus, embodiments described herein are not limited to any specific combination of hardware circuitry and software. For instance, the controller may, but is not limited to, manage or perform session-related activities (e.g., starting a session, ending a session, setting privileges in a session, accounting, etc.); participant-related activities (e.g., designating a host, establishing participant privileges, assigning a participant presenter privileges, etc.); content sharing-related activities (e.g., designating content to be shared, determining content sharing parameters, implementing sharing of content, displaying shared content, etc.); communication activities (e.g., handling communication between device and the network as well as with other devices, transmittal/receipt of shared content, etc.); and the like.

The term “computer-readable medium” as used herein refers to any medium that participates in providing instructions to processor 204 for execution. Such a medium may take many forms, including but not limited to non-volatile media, and volatile media. Non-volatile media include, for example, optical or magnetic disks, such as storage device 210. Volatile media include dynamic memory such as main memory 206. As used herein, tangible media may include volatile and non-volatile media. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

The participant device 200 also includes a communication interface 212 coupled to bus 202. Communication interface 212 provides a two-way data communication coupling participant device 200 to communication link 214. Communication link 214 typically provides data communication to other networks or devices. For example, communication interface 212 may be a local area network (LAN) card to provide a data communication connection to a compatible LAN. As another example, communication interface 212 may be an integrated services digital network (ISDN) card or a modem to provide a data communication connection to a corresponding type of telephone line. Wireless links may also be implemented. In any such implementation, communication interface 212 sends and receives electrical, electromagnetic, or optical signals that carry digital data streams representing various types of information. Although the illustrated example has one communication interface 212 and one communication link 214, those skilled in the art should readily appreciate that this is for ease of illustration, as the example embodiments described herein may have any physically realizable number of communication interfaces 212, and/or communication links 214.

The participant device 200 also includes at least one input/output interface 216 connected to the bus 202 and in data communication with one or more user interface devices, such as a mouse, keyboard, monitor/screen, etc. (not explicitly shown).

FIG. 3 illustrates an example implementation for a server 300 according to one or more embodiments described herein. The server 300 comprises a bus 302 or other communication mechanism for communicating information and a processor 304 coupled with the bus for processing information. The server 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. The server 300 further includes a read only memory (ROM) 308 or other static storage device coupled to bus 302 for storing static information and instructions for processor 304. The server may further comprise a storage device 310, such as a magnetic disk, optical disk, and/or flash storage, which is provided and coupled to bus 302 for storing information and instructions.

The processor 304, in connection with the main memory 306, is configured to implement the functionality described herein with reference to the participant device. The main memory 306 stores software programs or other executable program instructions associated with the embodiments described herein. Such instructions may be read into main memory 306 from another computer-readable medium, such as storage device 310.

The processor 304 comprises the necessary elements or logic adapted to execute the software programs to generally perform functions relating to collaborative computing sessions, as described herein. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement an example embodiment. Thus, embodiments described herein are not limited to any specific combination of hardware circuitry and software. For instance, the controller may, but is not limited to, manage or perform session-related activities (e.g., starting a session, ending a session, setting privileges in a session, accounting/tracking of sessions, etc.); participant-related activities (e.g., designating a host, establishing participant privileges, assigning a participant presenter privileges, maintaining participant information, etc.); content sharing-related activities (e.g., designating content to be shared, determining content sharing parameters, implementing sharing of content, formatting shared content, etc.); communication activities (e.g., handling communication between server and the network as well as with the participant devices, transmittal/receipt of shared content, etc.); and the like.

The server 300 also includes a communication interface 312 coupled to bus 302, for providing a two-way data communication coupling server 300 to communication link 314. Communication link 314 typically provides data communication to other networks or devices. Although the illustrated example has one communication interface 312 and one communication link 314, those skilled in the art should readily appreciate that this is for ease of illustration, as the example embodiments described herein may have any physically realizable number of communication interfaces 312, and/or communication links 314. The server 300 may further include at least one input/output interface 316 connected to the bus 302 and in data communication with one or more user interface devices, such as a mouse, keyboard, monitor/screen, etc. (not explicitly shown).

Notably, while the illustrative embodiment described below shows a single server as performing the functions described herein, it is understood that the server 300 may comprise, either as a single server or as a collection of servers, one or more memories, one or more processors, and one or more network interfaces (e.g., adapted to communicate traffic for a collaborative computing session and also traffic on a communication channel other than the collaborative computing session), etc., as may be appreciated by those skilled in the art.

Conventional application sharing techniques capture a predefined portion of the presenter's display (e.g., the entire screen or a rectangle within the entire screen) and provide the image within the predefined portion of the presenter's display to the viewer (e.g., “desktop sharing”). All of the applications that have windows positioned within the predefined portion of the presenter's display are captured by the presenter's device, transmitted to the viewer's device, and displayed on the viewer's display. In “application sharing,” the presenter selects which particular applications to share with the one or more attendees/viewers of a collaboration session. The presenter's device then provides the shared applications to the viewers' devices.

During a collaborative computing session, the presenter may suitably select at least a portion of the presenter's display to be shared with the other participants in the session. The presenter may also suitably invoke an application program on the presenter's device, such as a word processing program, and designate the application program to be shared with the other participants in the session. This causes the presenter's device to share the output generated by the application program on the presenter's device with the viewers' devices. It is understood that the shared application program is any suitable application, and may include, but is not limited to, a word processing application, a drawing or graphics application, presentation application, spreadsheet application, or other well-known interactive applications from which information is being shared by the presenter with the viewers.

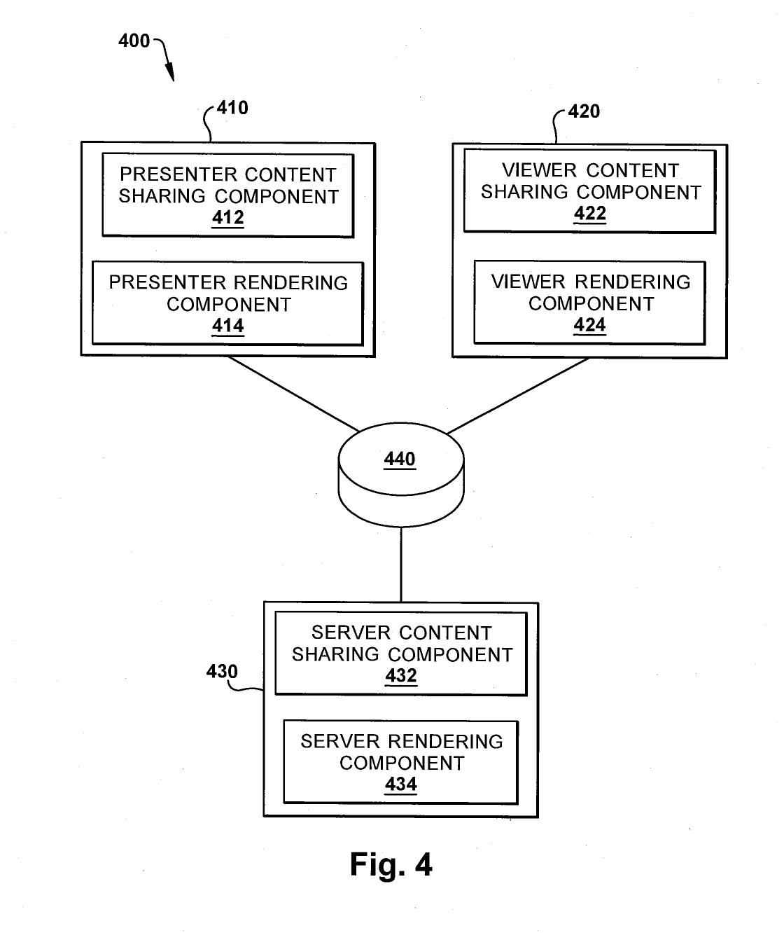

FIG. 4 illustrates an alternative view of network 100 (as shown in FIGS. 1-3) in accordance with content sharing. For instance, participant devices, may be further represented as further detailed in FIG. 4, to include a presenter device 410 and at least one viewer device 420. Presenter device 410 may comprise presenter content sharing component 412, which may be any type of suitable software that enables presenters and viewers to share applications, documents, or the like. Presenter device 410 may also comprise a rendering component 414 for rendering and/or formatting content to be transmitted to the viewers' devices. Presenter device 410 may also include other components that are not shown or discussed for simplicity.

It is to be understood that presenter content sharing component 412 and participant rendering component 414 may suitably be implemented as logic operable to be executed by participant device processor 204, as shown in FIG. 2. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

Viewer device 420 may also include viewer content sharing component 422, which may be any type of suitable software that enables presenters and viewers to share applications, documents, or the like. Viewer content sharing component 422 may be similar to or the same as presenter content sharing component 412. Viewer content sharing component 422, among other things, receives content from the presenter's device for display on the viewer's device. Viewer device 420 may also comprise a viewer rendering component 424 for rendering and/or formatting content to be displayed on the viewer's device. It is to be understood that viewer content sharing component 422 and viewer rendering component 424 may suitably be implemented as logic operable to be executed by participant device processor 204, as shown in FIG. 2.

Server 430 may also include server content sharing component 432, which may be any type of suitable software that enables presenters and viewers to share applications, documents, or the like. Server 430 may also comprise a server rendering component 434 for rendering and/or formatting content to be transmitted by a presenter device to a viewer's device, content to be displayed on the viewer's device, or a combination thereof. It is to be understood that server content sharing component 432 and server rendering component 434 may suitably be implemented as logic operable to be executed by server processor 304, as shown in FIG. 3.

It is to be understood that the rendering components 414, 424, and 434 suitably render, format, or otherwise modify the shared content for suitable transmission thereof to at least one viewer device, for suitable display thereof on at least viewer device, and combinations thereof. As used herein, the phrase “render” may be used to describe such rendering, formatting, or modification of the content.

According to collaborative content sharing, a presenter may select at least a portion of the presenter's display and/or at least one particular application to share with one or more attendees/viewers of a collaboration session. The presenter's device may then transmit, such as via presenter content sharing component 412, the shared content to the viewer's device, such as via viewer content sharing component 422, over network 440. It is understood that in an example embodiment, the server 430, together with the server content sharing component 432, may be configured to receive all or a selected portion of content from the presenter device and transmit the received content to the designated viewer devices. The server 430, together with the server rendering component 434, may also be configured to render at least a portion of the content received from the presenter device. In one embodiment, the server 430 may suitably render at least a portion of the content received from the presenter device and transmit the rendered content to the designated viewer devices. In another embodiment, the server 430 may suitably render at least a portion of the content received from the presenter device, and then transmit the rendered content back to the presenter device for transmission therefrom to the designated viewer devices.

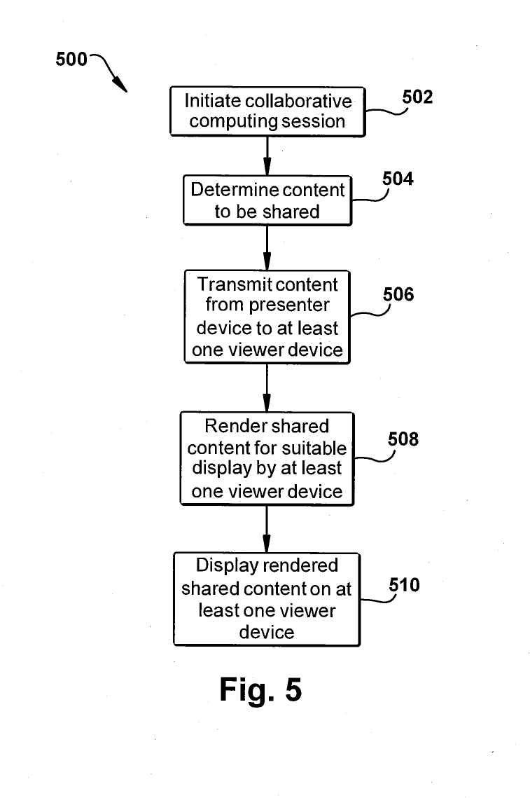

In view of the foregoing structural and functional features described above, methodologies in accordance with example embodiments will be better appreciated with reference to FIGS. 5, 11, and 13. While, for purposes of simplicity of explanation, the methodologies of FIGS. 5, 11, and 13 are shown and described as executing serially, it is to be understood and appreciated that the example embodiment is not limited by the illustrated order, as some aspects could occur in different orders and/or concurrently with other aspects from that shown and described herein. Moreover, in accordance with an example embodiment, not all illustrated features may be required. The methodologies described herein are suitably adapted to be implemented in hardware, software, or a combination thereof. For example, the methods may be implemented by participant devices 102, server 104, or combinations thereof.

FIG. 5 is a flow chart of an example method 500 for sharing content in collaborative computing sessions as described herein. Method 500 may suitably be implemented on a system for content sharing in collaborative computing sessions as described herein.

At 502, a collaborative computing session is initiated among a plurality of participant devices 200, as is known in the art. For example, the collaborative computing session initiation process may suitably occur in a participant device 200 through interaction with server 300, or through server 300, with interaction with at least one participant device 200. Participant devices 200 may join the collaborative computing session through login and/or authentication processes or protocols as are known in the art. At least one of the participant devices is designated as a presenter device 410, such as the meeting host or coordinator, wherein such presenter device includes a presenter content sharing component 412 operating to allow the presenter device to share selected content with other participant devices or viewer devices 420, as will be described in detail below.

At 504, the presenter, via the presenter device 410 selects or otherwise determines content to be shared with the other participants in the session as is known in the art. The presenter may suitably select at least a portion of the presenter device's display to be shared with the other participants in the session. The presenter may also suitably invoke an application program on the presenters device, such as a word processing program, and designate the application program to be shared with the other participants in the session.

At 506, the selected content to be shared by the presenter device 410 is transmitted via suitable means, such as via the network 106, to at least one viewer device 420 for sharing thereof. It is understood that in some embodiments, the shared content may be transmitted directly from the presenter device 410 to at least one viewer device 420. It is further understood that in other embodiments, at least a portion of the shared content is transmitted from the presenter device 410 to the server 430, and then the server transmits such shared content to the at least one viewer device 420.

At 508, the shared content is rendered, via a rendering component, for suitable display on the at least one viewer device. The illustrated example depicts that the shared content is transmitted from the presenter device 410 to the at least one viewer device 420, and then the shared content is rendered accordingly. However, it is understood that in some embodiments, the shared content may be rendered for display on the at least one viewer device prior to transmission of the content to the at least one viewer device.

In one embodiment, the presenter device 410, via the presenter device rendering component 414, may render the shared content for at least one viewer device, for several specified viewer devices, for all of the viewer devices, or combinations thereof, and then transmit the rendered shared content accordingly. In another embodiment, the presenter device 410 may transmit at least a portion of the shared content to the server 430. The server 430, via the server rendering component 434, may render the shared content for at least one viewer device, for several specified viewer devices, for all of the viewer devices, or combinations thereof, and then transmit the rendered shared content accordingly. In another embodiment, the presenter device 410, either directly or via the server 430, may transmit the shared content to the viewer device 420. The viewer device will then suitably render the received shared content for suitable display on the viewer device. In yet another embodiment, the presenter device 410 and/or the server 430 may performing a render operation on the shared content, and then transmit the content to the at least one viewer device. The viewer device 420 may suitably perform a further rendering operation the received shared content for suitable display on the viewer device.

At 510, the shared content is displayed on the at least one viewer device 420.

It is to be appreciated that the participant devices 200, including both the presenter device 410 and the viewer device 420, can range from full capability workstation or desktop computing systems to handheld portable devices, such as a cellular telephone or personal digital assistant with less or limited rendering and/or sharing capability. The system and methods set forth herein are suitably robust to address and account for all ranges of participant device capabilities.

In conventional desktop or application sharing, the presenter designates at least a portion of the presenter's display to be shared; an application program, including all windows associated with such application to be shared; or a combination thereof. The content as displayed on the presenter's device is then displayed on the viewer devices. The content as displayed on the presenter's device may include background regions or content that is not relevant to the viewer. For example, if the presenter designates an application to be shared, such application may have several windows associated with the application and displayed on the presenter device. Typically, there are regions or space between the relevant windows as displayed on the presenter device. Such regions may suitably display a background of the presenter device display, or other content or applications not relevant to the viewer or the collaborative computing session.

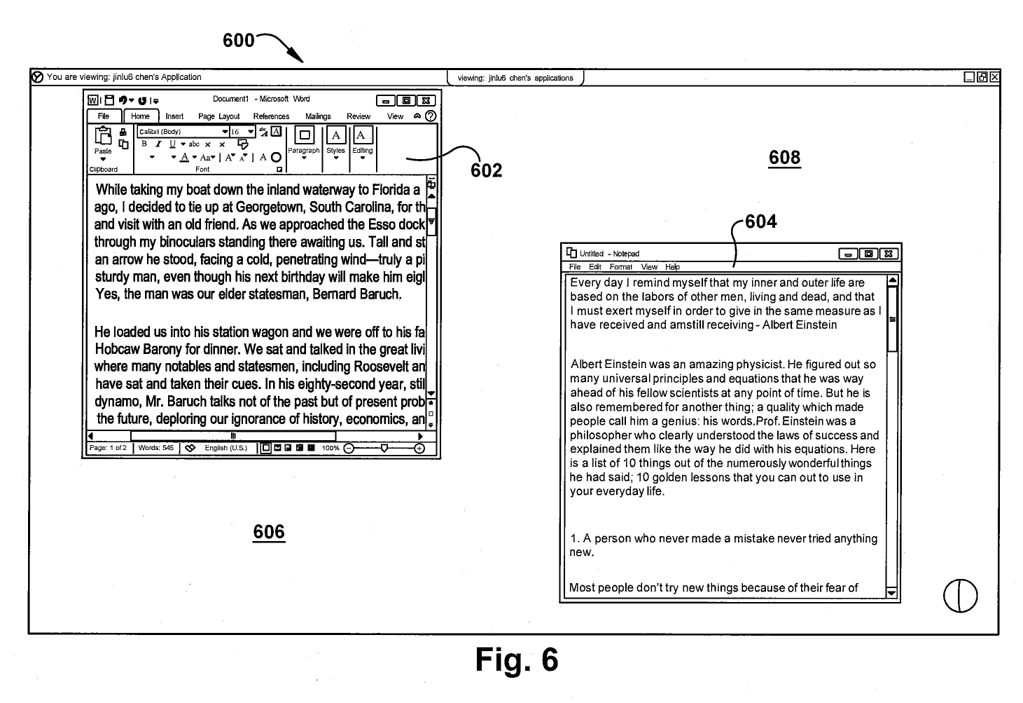

An example of a display 600 of a presenter device, wherein the presenter has enabled application sharing during a collaborative computing session with other viewer devices, is illustrated in FIG. 6. As illustrated in FIG. 6, windows 602 and 604 are the active windows for the shared application. The other regions, 606 and 608, of the display 600 are not part of the shared application. Those regions, 606 and 608, which are not part of the shared application will be referred to herein as “background regions”.

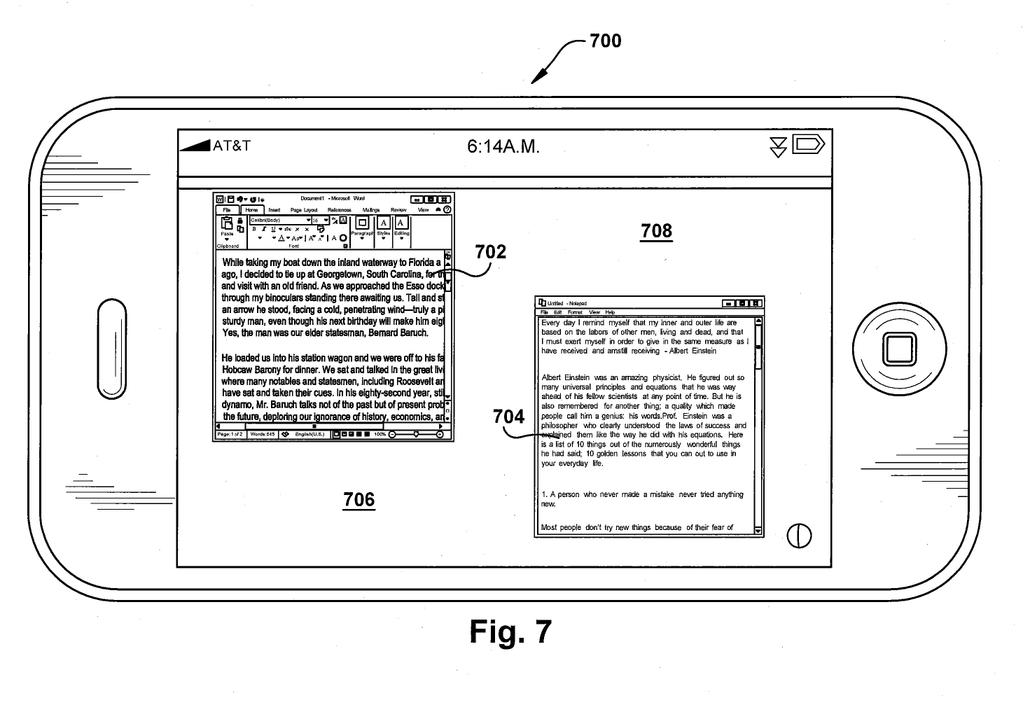

When the shared content as illustrated in FIG. 6 is transmitted to a viewer device, without rendering the content for suitable display on the viewer device, the content is displayed on the viewer device as it is displayed on the presenter device. An example of a viewer display 700 of shared content transmitted without rendering is shown in FIG. 7. The display includes active windows 702 and 704 for the shared application, as well as background regions 706 and 708, which are not part of the shared application. If the participant is viewing the shared content on a viewer device having a small display, such as a handheld portable device, as shown in FIG. 7, the shared content may be difficult to view or comprehend due to the small size of the display. As further illustrated in FIG. 7, a large portion of the display is being used for background regions 706 and 708.

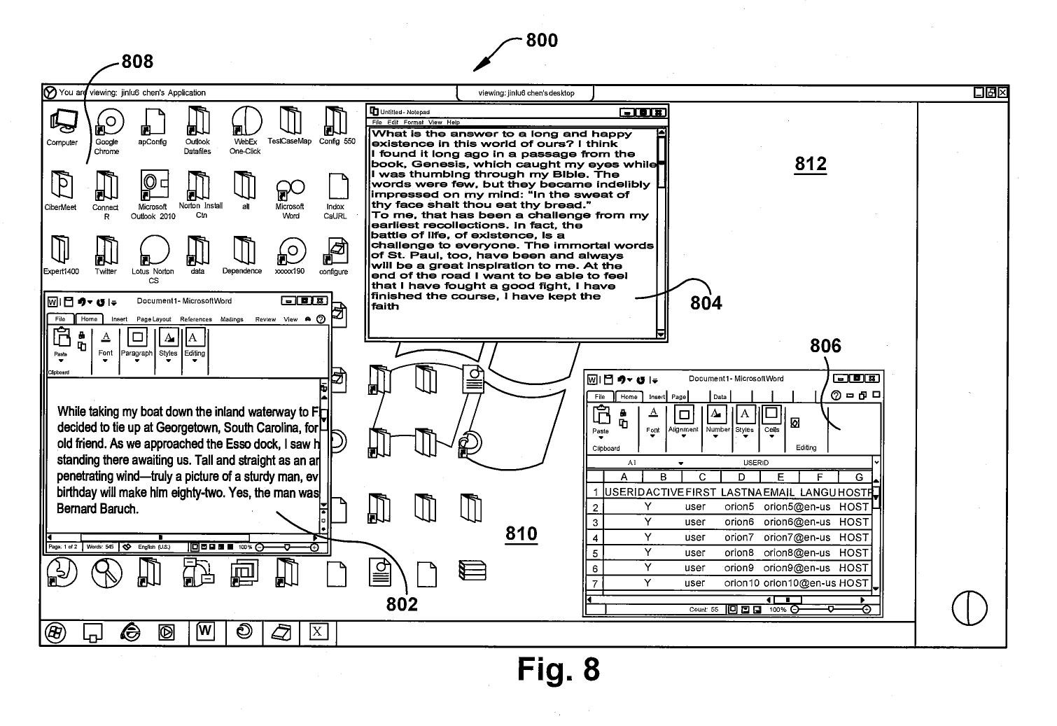

An example of a display 800 of a presenter device, wherein the presenter has enabled desktop sharing during a collaborative computing session with other viewer devices, is illustrated in FIG. 8. As illustrated in FIG. 8 windows or regions 802, 804, and 806 are relevant to or the focus of the collaborative computing session. The other regions 808, 810, and 812 of the display 800 are not of primary relevance, or possibly of any relevance, to the participants of the collaborative computing session. Regions 808, 810, and 812, which are not of primary relevance, will be referred to herein as “background regions”.

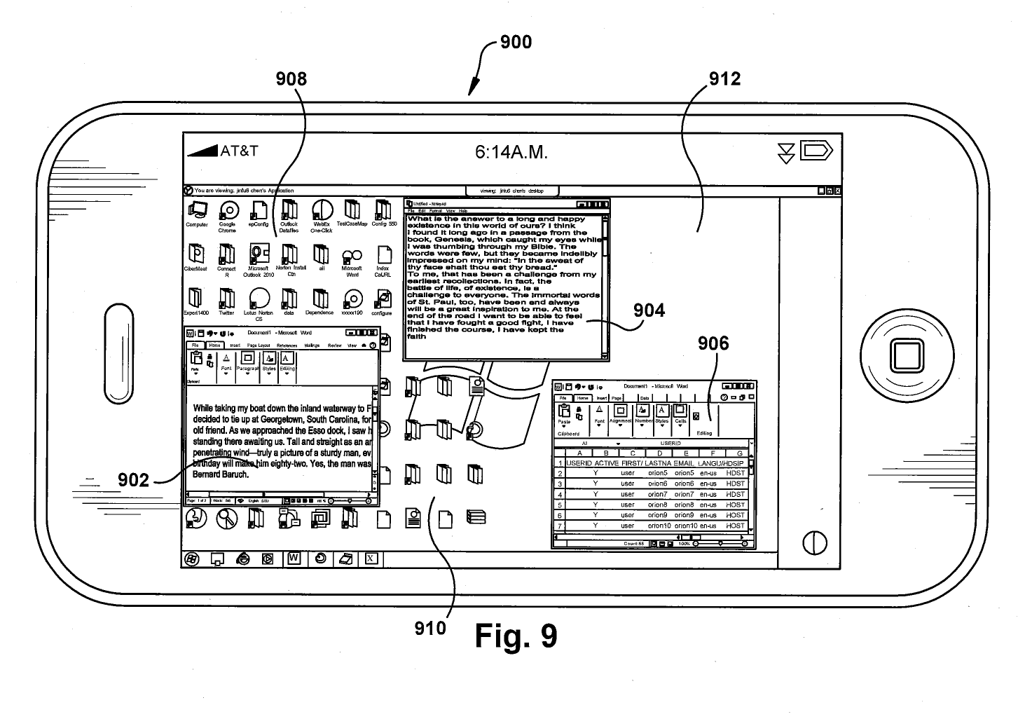

When the shared content as illustrated in FIG. 8 is transmitted to a viewer device, without rendering the content for suitable display on the viewer device, the content is displayed on the viewer device as it is displayed on the presenter device. An example of a viewer display 900 of shared content transmitted without rendering is shown in FIG. 9. The display includes relevant windows or regions 902, 904, 906, as well as background regions 908, 910, and 912, which are not of primary relevance to the viewer. If the participant is viewing the shared content on a viewer device having a small display, such as a handheld portable device, as shown in FIG. 9, the shared content may be difficult to view or comprehend due to the small size of the display. As further illustrated in FIG. 9, a large portion of the display is being used for background regions 908, 910, and 912.

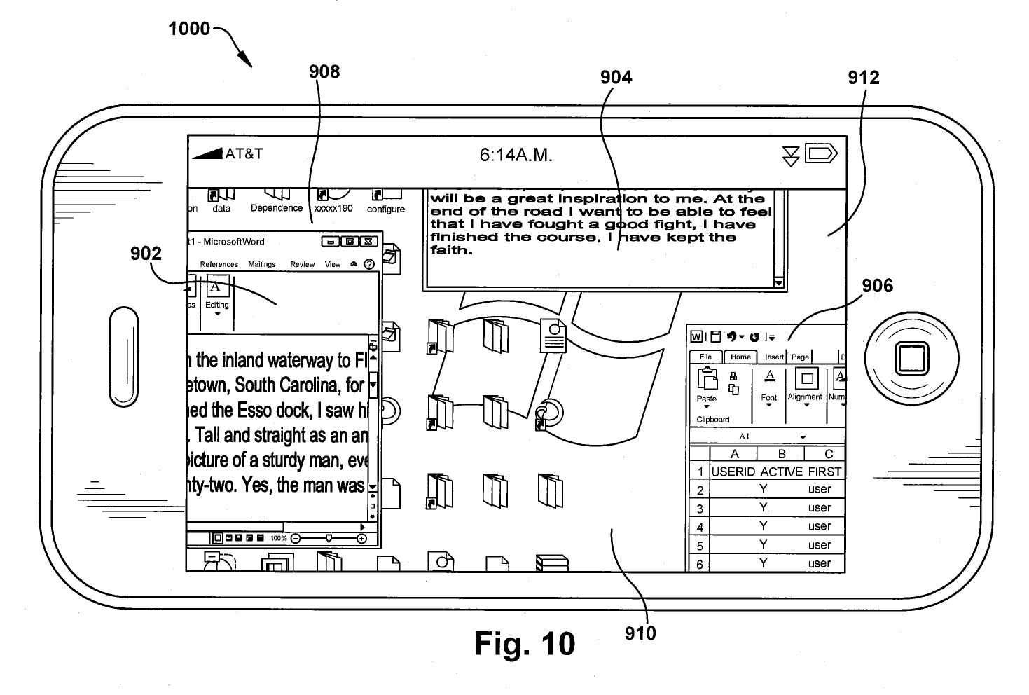

In such situations, the viewer may desire to enlarge or increase the size of the shared content for easier viewing of the content. For instance, the user may zoom into or otherwise enlarge at least a portion of the shared content by any suitable means for the particular viewer device. FIG. 10 is a display 1000 on a viewer device wherein the shared content has been increased in size or enlarged. As illustrated in FIG. 10, due to the small size of the screen, enlarging the shared content results in the viewer not being able to view all of the relevant windows 902, 904, and 906 at the same time. A large portion of the display on the viewer device is being used by background regions 908, 910, and 912.

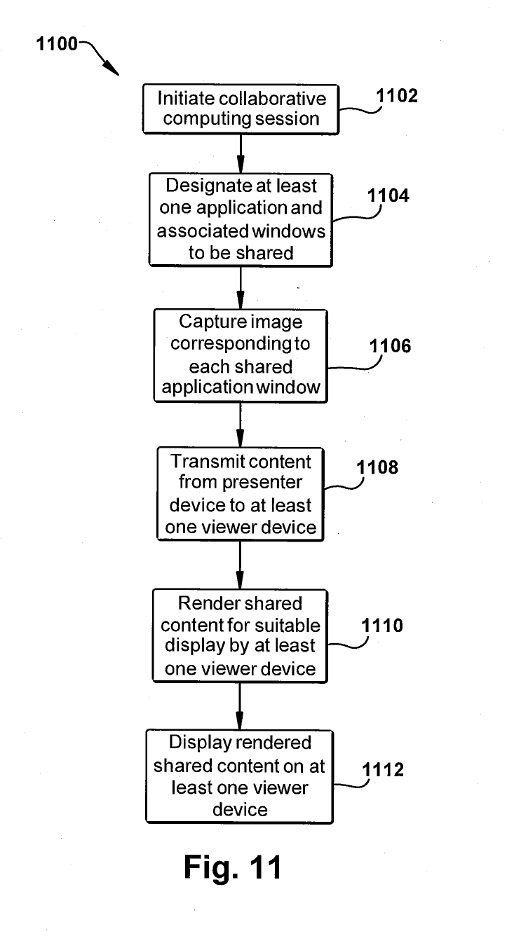

FIG. 11 is a flow chart of an example method 1100 for application sharing in collaborative computing sessions as described herein. Method 1100 may suitably be implemented on a system for content sharing in collaborative computing sessions as described herein.

At 1102, a collaborative computing session is initiated among a plurality of participant devices 200, as is known in the art and as discussed above. At least one of the participant devices is designated as a presenter device 410, such as the meeting host or coordinator, wherein such presenter device includes a presenter content sharing component 412 operating to allow the presenter device to share selected content with other participant devices or viewer devices 420, as will be described in detail below.

At 1104, the presenter, via the presenter device 410 selects or otherwise designates at least one application program, including all associated windows, to be shared with the other participants in the session as is known in the art.

At 1106, an image or data corresponding to (or “within”) each shared application window on the presenter device is captured so that it can be provided to the viewer devices as is known in the art. This step may be performed periodically (e.g., five times per second) so that changes to the presenter's display are quickly reflected on the viewer devices. Illustratively, the image or data corresponding to each shared application window can be captured by capturing portions of the frame buffer on the presenter device that correspond to the shared application windows.

At 1108, the selected content to be shared by the presenter device 410 is transmitted via suitable means, such as via the network 106, to at least one viewer device 420 for sharing thereof. It is understood that in some embodiments, the shared content may be transmitted directly from the presenter device 410 to at least one viewer device 420. It is further understood that in other embodiments, at least a portion of the shared content is transmitted from the presenter device 410 to the server 430, and then the server transmits such shared content to the at least one viewer device 420. In an example embodiment, prior to transmission, the image or data corresponding to the shared content may be suitably compressed using known compression techniques, such as GZIP or JPEG.

At 1110, the shared content is rendered, via a rendering component, for suitable display on the at least one viewer device. The illustrated example depicts that the shared content is transmitted from the presenter device 410 to the at least one viewer device 420, and then the shared content is rendered accordingly. However, it is understood that in some embodiments, the shared content may be rendered for display on the at least one viewer device prior to transmission of the content to the at least one viewer device.

In one embodiment, the presenter device 410, via the presenter device rendering component 414, may render the shared content for at least one viewer device, for several specified viewer devices, for all of the viewer devices, or combinations thereof, and then transmit the rendered shared content accordingly. In another embodiment, the presenter device 410 may transmit at least a portion of the shared content to the server 430. The server 430, via the server rendering component 434, may render the shared content for at least one viewer device, for several specified viewer devices, for all of the viewer devices, or combinations thereof, and then transmit the rendered shared content accordingly. In another embodiment, the presenter device 410, either directly or via the server 430, may transmit the shared content to the viewer device 420. The viewer device will then suitably render the received shared content for suitable display on the viewer device. In yet another embodiment, the presenter device 410 and/or the server 430 may performing a render operation on the shared content, and then transmit the content to the at least one viewer device. The viewer device 420 may suitably perform a further rendering operation of the received shared content for suitable display on the viewer device.

In an example embodiment, the shared content is rendered for suitable display for at least one viewer device based on the capabilities of the at least one viewer device. As an example, if the viewer device is a handheld portable device having a small display, the shared content will be suitably rendered for display to efficiently use the display area for the shared content. In an example embodiment, the shared content is suitably rendered for display on the handheld portable device to ensure that the relevant content is predominantly displayed for viewing by the user of the device, while minimizing the display of any background regions.

In an example embodiment, the shared content is rendered for suitable display on the at least one viewer device, such that the relevant content is displayed in the central portion of the viewer display, and the background regions are displayed on the periphery of the display, if displayed at all. As an example, the shared content is rendered such that all of the windows associated with the shared application are displayed side by side, or contiguously, without displaying any of the background regions therebetween. In the rendering of the shared content, any background region which was shown or displayed between the windows of the shared application on the presenter display is minimized on the viewer display. The rendering component of the presenter device, the viewer device, the server, or a combination thereof, suitably block or remove the background region image or data from displaying on the viewer device as is known in the art.

It is understood that each viewer device may have differing capabilities which will provide for different display configurations. For example, one handheld portable device, such as tablet, may have a larger display than another handheld portable device, such as a cellular telephone. As such, the rendering required (e.g., minimization of background regions) for the tablet may suitably be less than the rendering required for the cellular telephone. It is understood that the rendering component of the presenter device, the viewer device, the server device, or a combination thereof will suitably provide the rendering required in accordance with each device's capabilities.

At 1112, the shared content is displayed on the at least one viewer device 420.

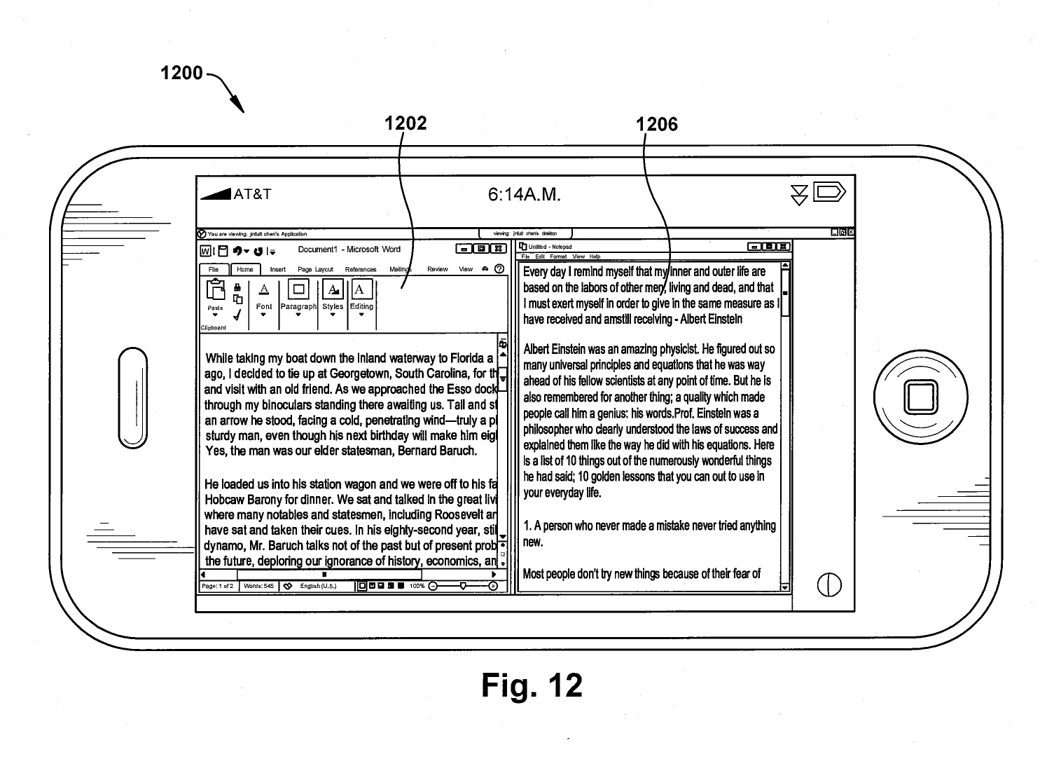

FIG. 12 illustrates an example of a viewer display 1200 of shared content that has been suitably rendered for display on the viewer device. As illustrated in the viewer display 1200, relevant windows 1202 and 1204 of the shared application are displayed side by side. Any background region images or data between the windows as displayed on the presenter device has been blocked or removed from the display on the viewer device.

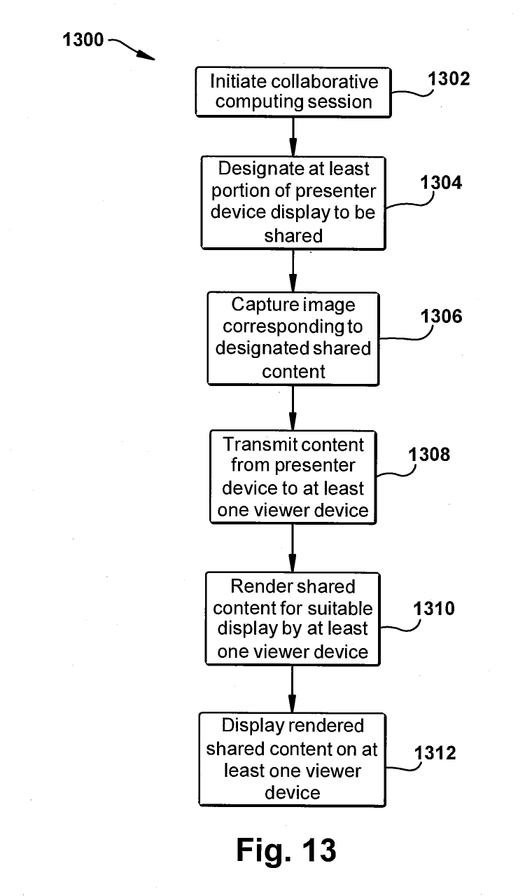

FIG. 13 is a flow chart of an example method 1300 for desktop sharing in collaborative computing sessions as described herein. Method 1300 may suitably be implemented on a system for content sharing in collaborative computing sessions as described herein.

At 1302, a collaborative computing session is initiated among a plurality of participant devices 200, as is known in the art and as discussed above. At least one of the participant devices is designated as a presenter device 410, such as the meeting host or coordinator, wherein such presenter device includes a presenter content sharing component 412 operating to allow the presenter device to share selected content with other participant devices or viewer devices 420, as will be described in detail below.

At 1304, the presenter, via the presenter device 410 selects or otherwise designates at least a portion of the presenter device's display or desktop to be shared with the other participants in the session as is known in the art.

In an example embodiment, the shared content may be selected or designated based on content type, content importance, user activity associated with the content, other content characteristics or features, and combinations thereof. In another example embodiment, the shared content may be selected or designated by the user, by the presenter device via the presenter content sharing component, by the viewer device by the viewer sharing component, by the server by the server content sharing component, and combinations thereof.

In an example embodiment, the shared content is suitably designated based on a determined activity or priority level of selected windows or content regions displayed on the presenter device. As an example, the presenter device may have multiple applications running or executing thereon, with each application including at least one active or open window associated therewith. For instance, the presenter device may have a word processing application executing with two active document windows, an email application program executing with one active window, and a graphics application with two active windows, as well as the background window.

In an example embodiment, the presenter device, via the presenter content sharing component, will determine the priority level for each application and/or window in order to designate or determine which is to be shared with the viewer devices. For simplicity purposes, “window” will refer to an application, a window associated with an application, and/or background windows or regions. It is understood that the server, via the server content sharing component, may suitably determine or assist in the determination of the priority level for each window or a portion of the windows. It is further understood that the viewer device, via the viewer content sharing component, may assist in the determination of the priority level window or a portion of the windows as is needed for efficient display by a viewer device.

In an example embodiment, the window priority (P) is suitably determined as function of window duration (t), which is the total amount of time the window is active; and window activity index (L), which is the number of user input events (e), such as click, scrolls, keystrokes, and the like in the window, over a sample period of time (T). The criteria for determining window priority (P) may be set by the presenter or other participant, or may be set automatically by the presenter content sharing component, the server content sharing component, and/or the viewer content sharing component, or a combination thereof.

In an example embodiment, the window or windows with the highest window priority (P) will be designated to be shared with the viewer devices. As an example, if the presenter is or has been actively using a word processing application for a period of time or repeatedly and has not been accessing an email application as frequently, then the window or windows associated with the word processing application will be determined to have a higher window priority (P) than the email application.

In an example embodiment, the active window duration (t) may be determined based on the amount of time the window has been running for a period of time, the amount of time the window has been accessed by the presenter for a period of time, and the like. In an example embodiment, the window activity index (L) may be determined based on the number of user input events, such as clicking on the window, scrolls, keystrokes, views, and the like. The number of user input events may be suitably measured or determined by any user participation measuring mechanism known in the art. In an example embodiment, the active window duration (t) and the window activity index (L) is determined for each window on the presenter device to determine the window priority (P) for each window. The window or windows with the highest window priority (P) will be designated as the windows for the shared content. It is understood that in some embodiments, the window priority (P) may not be determined for each window, such as those windows which are not likely to be shared, such as background windows. In such situations, the presenter and/or the content sharing component(s) designate or specify that the window priority (P) is not determined for certain windows.

In an example embodiment, the presenter and/or the content sharing component(s) may suitably set or determine a window priority (P) threshold for determining if a window is to be shared. The window priority (P) threshold may suitably be a default setting, which may be modified as necessitated. If the window priority (P) for a certain window is below the threshold, the window is not shared. If the window priority (P) for a certain window is above the threshold, the window is shared. It is understood that the presenter and/or the content sharing component(s) may suitably modify the threshold as is required or desired. It is further understood that the presenter and/or the content sharing component(s) may suitably override the threshold for a certain window. As an example, a window may have a window priority (P) below the threshold, but the presenter and/or the content sharing components may override the threshold requirement, and allow the window to be shared.

In an example embodiment, the presenter and/or the content sharing component(s) may suitably designate different modes or levels for sharing of content based on determined window priority (P) values. For example, the presenter and/or content sharing component(s) may set a window priority (P) high threshold, such that only windows exceeding such high threshold may be shared. In another example, the presenter and/or content sharing component(s) may set a more moderate threshold, such that only windows exceeding the moderate threshold may be shared. In yet another example, the presenter and/or the content sharing component may set a low threshold, which is met by most windows, and only those windows with a window priority (P) value below such threshold are not shared. It is understood that the different modes for sharing may also suitably be designated by application type, by device type, by content type, and the like.

As an example, a high window priority (P) threshold level could be set for handheld portable viewer devices, and a moderate window priority (P) threshold level could be set for desktop viewer devices. For instance, a presenter device could have a display size of 1024×768, and there are two active windows displayed thereon. The first active window W1, has a first priority, and its size is 360×240. The second active window has a second priority, and its size is 200×240. A first viewer device has a display size of 800×600. Both of the windows as shown on the presenter device display will be able to be displayed on the first viewer device, so window W1 and window W2 are shared with the first viewer device. A second viewer device has a display size of 360×240. Both of the windows as shown on the presenter device are not able to be displayed on the second viewer device. Therefore, only window W1 will be displayed on the second viewer device.

In an example embodiment, the presenter and/or the content sharing component(s) may suitably set or determine a window priority (P) threshold for determining if a window is to be shared. The window priority (P) threshold may suitably be a default setting, which may be modified as necessitated. The threshold may be modified by the presenter based on certain factors, such as content type, content importance, user activity associated with the content, other content characteristics or features, presenter device type, viewer device type and the like. The threshold may also suitably be modified by the content sharing component(s) based on prior or learned window priority (P) values determined for selected windows. Such learned window priority (P) value determination may be suitably performed by any self-learning algorithm known in the art.

At 1306, an image or data corresponding to the designated shared content designated on the presenter device is captured so that it can be provided to the viewer devices as is known in the art. This step may be performed periodically (e.g., five times per second) so that changes to the presenter's display are quickly reflected on the viewer devices. Illustratively, the image or data corresponding to the designated shared content can be captured by capturing portions of the frame buffer on the presenter device that correspond to the shared application windows.

At 1308, the selected content to be shared by the presenter device 410 is transmitted via suitable means, such as via the network 106, to at least one viewer device 420 for sharing thereof. It is understood that in some embodiments, the shared content may be transmitted directly from the presenter device 410 to at least one viewer device 420. It is further understood that in other embodiments, at least a portion of the shared content is transmitted from the presenter device 410 to the server 430, and then the server transmits such shared content to the at least one viewer device 420. In an example embodiment, prior to transmission, the image or data corresponding to the shared content may be suitably compressed using known compression techniques, such as GZIP or JPEG.

At 1310, the shared content is rendered, via a rendering component, for suitable display on the at least one viewer device. The illustrated example depicts that the shared content is transmitted from the presenter device 410 to the at least one viewer device 420, and then the shared content is rendered accordingly. However, it is understood that in some embodiments, the shared content may be rendered for display on the at least one viewer device prior to transmission of the content to the at least one viewer device.

In one embodiment, the presenter device 410, via the presenter device rendering component 414, may render the shared content for at least one viewer device, for several specified viewer devices, for all of the viewer devices, or combinations thereof, and then transmit the rendered shared content accordingly. In another embodiment, the presenter device 410 may transmit at least a portion of the shared content to the server 430. The server 430, via the server rendering component 434, may render the shared content for at least one viewer device, for several specified viewer devices, for all of the viewer devices, or combinations thereof, and then transmit the rendered shared content accordingly. In another embodiment, the presenter device 410, either directly or via the server 430, may transmit the shared content to the viewer device 420. The viewer device will then suitably render the received shared content for suitable display on the viewer device. In yet another embodiment, the presenter device 410 and/or the server 430 may performing a render operation on the shared content, and then transmit the content to the at least one viewer device. The viewer device 420 may suitably perform a further rendering operation of the received shared content for suitable display on the viewer device.

In an example embodiment, the shared content is rendered for suitable display for at least one viewer device based on the capabilities of the at least one viewer device. As an example, if the viewer device is a handheld portable device having a small display, the shared content will be suitably rendered for display to efficiently use the display area for the shared content. In an example embodiment, the shared content is suitably rendered for display on the handheld portable device to ensure that the relevant content is predominantly displayed for viewing by the user of the device, while minimizing the display of any background regions.

In an example embodiment, the shared content is rendered for suitable display on the at least one viewer device, such that the relevant content is displayed in the central portion of the viewer display, and the background regions are displayed on the periphery of the display, if displayed at all. As an example, the shared content is rendered such that all of the relevant content or windows are displayed side by side, or contiguously, without displaying any of the background regions therebetween. In the rendering of the shared content, any background region which was shown or displayed between relevant content on the presenter display is minimized on the viewer display. The rendering component of the presenter device, the viewer device, the server, or a combination thereof, suitably block or remove the background region image or data from displaying on the viewer device as is known in the art.

It is understood that each viewer device may have differing capabilities which will provide for different display configurations. For example, one handheld portable device, such as tablet, may have a larger display than another handheld portable device, such as a cellular telephone. As such, the rendering required (e.g., minimization of background regions) for the tablet may suitably be less than the rendering required for the cellular telephone. It is understood that the rendering component of the presenter device, the viewer device, the server device, or a combination thereof will suitably provide the rendering required in accordance with each device's capabilities.

At 1312, the shared content is displayed on the at least one viewer device 420.

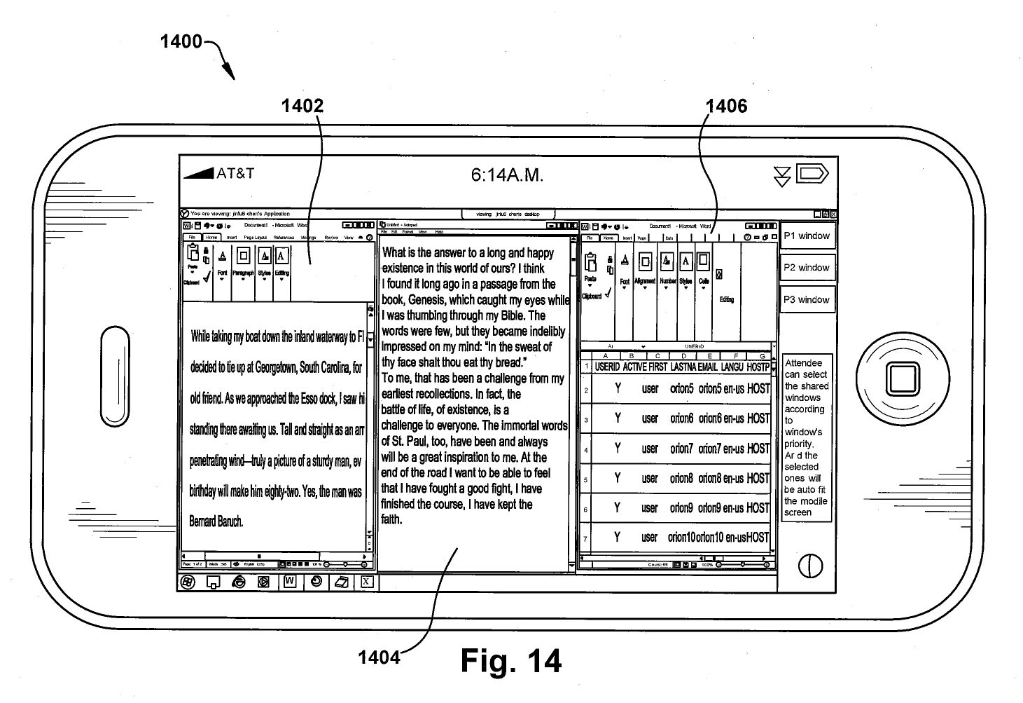

FIG. 14 illustrates an example of a viewer display 1400 of shared content that has been suitably rendered for display on the viewer device. As illustrated in the viewer display 1400, relevant windows 1402, 1404, and 1406 of the shared content are displayed side by side. Any background region images or data between the windows as displayed on the presenter device has been blocked or removed from the display on the viewer device.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. A method, comprising:
initiating a collaborative computing session between a plurality of participant devices in data communication with each other, wherein at least one participant device operates as a presenter device to share data associated with the group consisting of at least one application program executing on the presenter device, a predefined area of a display of the presenter device, and combinations thereof, with at least one other participant viewer device;
designating data associated with the group consisting of at least one application program executing on the presenter device, a predefined area of the display of the presenter device, and combinations thereof, to be shared with at least one viewer device;
transmitting the designated shared data to the at least one viewer device;
rendering the shared data for display on at least one viewer device, wherein the shared data is rendered in accordance with display capabilities of the at least one viewer device; and
displaying the rendered shared data on the at least one viewer device.

2. The method of claim 1, wherein designating data to be shared with at least one viewer device comprises designating at least one application program executing on the presenter device to be shared with the at least one viewer device, wherein the at least one application program includes at least one window generated by the at least one application program.

3. The method of claim 2, wherein the display on the presenter device comprises at least one window generated by the at least one application program and at least one background region; and wherein rendering the shared data for display on the at least one viewer device comprises rendering the shared data such that the shared data will be displayed to maximize the display of the at least one window generated by the at least one application program while minimizing the display of the at least one background region.

4. The method of claim 3, wherein rendering the shared data for display on the at least one viewer device comprises rendering the shared data such that the at least one window generated by the at least one application program will be displayed on the at least one viewer device and at least a portion of the at least one background region will be blocked from being displayed on the at least one viewer device.

5. The method of claim 1, wherein designating data to be shared with at least one viewer device comprises designating a predefined area of the display of the presenter device, wherein the predefined area includes at least one window generated by at least one application program executing on the presenter device and at least one background region

6. The method of claim 5, wherein designating data to be shared with at least one viewer device comprises determining a window priority for each window within the predefined area of the display on the presenter device, and designating a window for sharing with at least one viewer device based on the determined window priority.

7. The method of claim 6, wherein determining a window priority for each window comprises determining a window priority level as a function of the group consisting of window duration, wherein the window duration is the total amount of time the window is active; window activity index, wherein the window activity level is the number of user input events in the window; and combinations thereof, over a sample period of time.

8. The method of claim 6, wherein designating data to be shared with at least one viewer device further comprises determining a specified window priority level threshold, and designating a window for sharing based on the window priority level for the window exceeding the specified window priority level threshold.

9. The method of claim 5, wherein rendering the shared data for display on the at least one viewer device comprises rendering the shared data such that the shared data will be displayed to maximize the display of the at least one window within the predefined area on the display of the presenter device while minimizing the display of the at least one background region within the predefined area on the display of the presenter device.

10. The method of claim 9, wherein rendering the shared data comprises rendering the shared data such that the at least one window within the predefined area will be displayed on the at least one viewer device and at least a portion of the at least one background region within the predefined area will be blocked from being displayed on the at least one viewer device.

11. The method of claim 1, wherein rendering the shared data comprises rendering the shared data for each viewer device in accordance with display capabilities of each one viewer device.

12. An apparatus, comprising:
at least one network interface configured to transmit and receive data on a computer network;
a plurality of participant devices in data communication with each other via the network;
a processor coupled to the at least one network interface and configured to execute one or more processes; and
a memory configured to store a collaboration process executable by the processor, the collaboration process when executed operable to:
initiate a collaborative computing session between the plurality of participant devices in data communication with each other, wherein at least one participant device operates as a presenter device to share data associated with the group consisting of at least one application program executing on the presenter device, a predefined area of a display of the presenter device, and combinations thereof, with at least one other participant viewer device;
designate data associated with the group consisting of at least one application program executing on the presenter device, a predefined area of the display of the presenter device, and combinations thereof, to be shared with at least one viewer device;
transmit the designated shared data to the at least one viewer device;
render the shared data for display on at least one viewer device, wherein the shared data is rendered in accordance with display capabilities of the at least one viewer device; and
display the rendered shared data on the at least one viewer device.

13. The apparatus of claim 13, wherein the processor is further operable to designate at least one application program executing on the presenter device to be shared with the at least one viewer device, wherein the at least one application program includes at least one window generated by the at least one application program.

14. The apparatus of claim 13, wherein the display on the presenter device comprises at least one window generated by the at least one application program and at least one background region; and wherein the processor is further operable to render the shared data such that the shared data will be displayed to maximize the display of the at least one window generated by the at least one application program while minimizing the display of the at least one background region.

15. The apparatus of claim 14, wherein the processor is further operable to render the shared data such that the at least one window generated by the at least one application program will be displayed on the at least one viewer device and at least a portion of the at least one background region will be blocked from being displayed on the at least one viewer device.

16. The apparatus of claim 13, wherein the processor is further operable to designate a predefined area of the display of the presenter device to be shared with the at least one viewer device, wherein the predefined area includes at least one window generated by at least one application program executing on the presenter device and at least one background region

17. The apparatus of claim 16, wherein the processor is further operable to determine a window priority for each window within the predefined area of the display on the presenter device, and designating a window for sharing with at least one viewer device based on the determined window priority.

18. The apparatus of claim 17, wherein the processor is further operable to determine a window priority level as a function of the group consisting of window duration, wherein the window duration is the total amount of time the window is active; window activity index, wherein the window activity level is the number of user input events in the window; and combinations thereof, over a sample period of time.

19. The apparatus of claim 17, wherein the processor is further operable to determine a specified window priority level threshold, and designate a window for sharing based on the window priority level for the window exceeding the specified window priority level threshold.

20. The apparatus of claim 16, wherein the processor is further operable to render the shared data such that the shared data will be displayed to maximize the display of the at least one window within the predefined area on the display of the presenter device while minimizing the display of the at least one background region within the predefined area on the display of the presenter device.

21. The apparatus of claim 20, wherein the processor is further operable to render the shared data such that the at least one window within the predefined area will be displayed on the at least one viewer device and at least a portion of the at least one background region within the predefined area will be blocked from being displayed on the at least one viewer device.

22. The apparatus of claim 12, wherein rendering the shared data comprises rendering the shared data for each viewer device in accordance with display capabilities of each one viewer device.

23. Logic encoded in at least one non-transitory computer readable media for execution by a processor, and when executed by the processor operable to:
initiate a collaborative computing session between a plurality of participant devices in data communication with each other, wherein at least one participant device operates as a presenter device to share data associated with the group consisting of at least one application program executing on the presenter device, a predefined area of a display of the presenter device, and combinations thereof, with at least one other participant viewer device;
designate data associated with the group consisting of at least one application program executing on the presenter device, a predefined area of the display of the presenter device, and combinations thereof, to be shared with at least one viewer device;
transmit the designated shared data to the at least one viewer device;
render the shared data for display on at least one viewer device, wherein the shared data is rendered in accordance with display capabilities of the at least one viewer device; and
display the rendered shared data on the at least one viewer device.
